(19) United States
(12) Patent Application Publication
(10) Pub. No.: US 2007/0223705 A1
(43) Pub. Date: Sep. 27, 2007

(54) Storage Medium Processing Method, Storage Medium Processing Apparatus, and Program

(76) Inventors: Akihiro Kasahara, Chiba (JP); Akira Miura, Kanagawa (JP); Hiroshi Suu, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/571,064

(22) PCT Filed: Jun. 2, 2005
(86) PCT No.: PCT/JP05/10117

§ 371 Date: Dec. 21, 2006

(30) Foreign Application Priority Data
Jun. 28, 2004 (JP) 2004-189839

(51) Int. Cl. H04L 9/08

(52) U.S. Cl. 380/281

(57) ABSTRACT

User keys make sensitive management of users which are different per type of services.

A SD card SDq may store plural kinds of service user keys Kus which are different per type of services. The service user key Kus is encrypted by a medium unique key Kmu and is stored in a protection area 3. The protection area 3 stores a master user key Kumst encrypted by the medium unique key Kmu, as well as the service user keys Kus. The master user key Kumst is a key used for encrypting the service user key Kus when obtaining a service user key Kus.

### FIELD OF THE INVENTION

The present invention relates to a storage-medium processing method a system, and a program which enables a user terminal to acquire content data from a license center apparatus, by online-connecting a storage medium with a double key encryption scheme via the user terminal to the license center apparatus.

### BACKGROUND OF THE INVENTION

In recent years with development of information society, a content data distribution system is widely used. In this system the content data including electronic data such as a book, newspaper, music or an moving pictures is distributed to a user terminal, which enables browsing of content data in the user terminal.

However, since electric content data (heretofore, it is referred to as “content data”) can be copied easily, the electronic content data tends to induce illegal acts that disregard copyright. From a viewpoint of protecting content data from such an illegal act, content data is encrypted and recorded by the encryption key and is usually decoded at the time of reproducing.

Content data protection technologies like this include CPRM (Content Protection for Prerecorded Media) which uses a standardized encryption key scheme in SD audio, SD video, SD E-e-Publish (SD computer-assisted publishing) or the like (for example, refer to nonpatent literature 1). The encryption-key scheme adapted in this nonpatent literature 1 is an encryption single key scheme which encrypts a title key with a medium unique key. On the other hand, the encryption double key scheme in which the content key is doubly encrypted with the user key and the medium unique key is known (for example, refer to nonpatent literature 2). This kind of encryption double key scheme is used in MQbic (registered trademark), for example.

FIG. 9 is a schematic diagram showing the configuration of the SD card corresponding to the encryption double key scheme adopted in Mqbic. A SD card SDq is an example of a secure storage medium which securely stores data. The SD card SDq has a system area 1, a hidden area 2, a protected area 3, a user data area 4, and an encryption/decryption unit 5, and the data is stored in each area 1-4.

In a SD card SDq like this, key management information MKB (Media Key Block) and the medium identifier IDm are stored in the system area 1. The medium unique key Kmu is stored in the hidden area 2 The encrypted user key Enc (Kmu, Ku) is stored in the protection area 3, and the encrypted content key data Enc (Ku, Kc) is stored in the user data area 4. The expression of Enc (A, B) means the data B encrypted with data A in this specification Here, the user key Ku is encryption/decryption key to the content key Kc, and is used in common also to two or more sets of encrypted content key data Enc (Ku, Kc1), Enc (Ku, Kc2) . . . . Moreover, the subscript q of SD card SDq denotes that it conforms to MQbic (registered trademark).

Here, the system area 1 is a read-only area which can be accessed from outside of the SD card. The hidden area 2 is a read-only area that the SD card itself refers to, and cannot be accessed at all from external. The protection area 3 is an area in which data read and write is possible from external of the SD card when authentication is accomplished.

The user data area 4 is an area in which read/writing is freely possible from outside of the SD card The encryption/decryption unit 5 performs authentication, key exchanging, and cryptography, and has a function of encryption/decryption.

The user terminal 10q for reproducing operates logically as follows to such the SD card SDq. That is, the user terminal 10q, performs MKB processing of the key management information MKB read from the system area 1 of SD card SDq with the device key Kd set up beforehand (ST1), to obtain a medium key Km. Next, the user terminal 10q carries out the hash processing of both the medium key Km and the medium identifier IDm read from the system area 1 of the SD card SDq (ST2), and obtains the medium unique key Kmu

Thereafter, the user terminal 10q performs, based on the medium unique key Kmu, an authentication process and a key exchanging process (AKE: Authentication Key Exchange) with the decryption/encryption unit 5 of the SD card SDq, to share a session key with the SD card SDq (S3).

Note that the authentication and key exchanging process in the step ST3 succeeds when the medium unique key Kmu in the hidden area 2 referred to at the decryption/encryption unit 5 coincides with the medium unique key Kmu generated by the user terminal 10q, thereby the session key Ks being shared.

Then, the user terminal 10q reads out the encrypted user key Enc (Kmu, Ku) from the protection area 3, through a cipher communication using the session key Ks (S4). This results in the encrypted user key Enc (Kmu) being decrypted by the medium unique key Kmu (S5). Then, the user key Ku will be obtained.

Finally, when the encrypted content key Enc (Ku, Kc) is read from the user data area 4 of the SD card SDq, the user terminal 10q carries out the decryption processing of the encrypted content key Enc (Ku, Kc) with the user key Ku to obtain a content key Kc(ST5q). Finally, when the encrypted content data Enc (Kc, C) is read from Memory 11q, the user terminal 10q performs the decryption processing of the encrypted content data Enc (Kc, C) with the content key Kc (ST6). Thereby, the user terminal 10q reproduces the obtained content data C.

Note that although the above-mentioned example stores encrypted content data in the memory 11q of the user terminal 10q, it may be stored in the external storage medium.

The above-mentioned encryption double key scheme stores encrypted content key data at the user data area 4 having a large memory capacitance compared to the protection area 3 Therefore, i has an advantage in that it can store a lot of encrypted content key data compared to encryption single key scheme.

Moreover, since the encryption double key scheme may store encrypted content data in the SD card, it may urge the distribution of encrypted content data.

Furthermore, in the encryption double key scheme, the medium identifier as an identifier is given to each SD card, and a unique user key is issued per medium identifier This user key is also encrypted and stored in the protection area (protected area) of an SD card. Encryption of the user key depends on the medium identifier,and the user key can be decoded only with a authentic player For this reason, content data cannot be acquired even if a trespasser copies only a content key unjustly from a user data area.
[Nonpatent literature 1] 4C An entity, LLC, [online], Internet <URL:http://www.4Centity.com/, searched on June 14, 2004>
[Nonpatent literature 2] IT information site and ITmedia news [online],
Internet<URL:http:/www.itmedia.co.jp/news/0307/18/njbt_{—}02. html, searched on Jun. 14, 2004>

### DISCLOSER OF THE INVENTION

[Problem to be solved]

As mentioned above, the user key Ku is used in common also to two ore encryption content keys Enc (Ku, Kc1), Enc (Ku, Kc2), and—in the same SD card SDq.

By the way, when such a content data distribution system spreads, the number of the companies that provide services will increase and there will be an abundant number of categories, formats or the like of services. In that case, it is expected that sufficient services with such a single user key becomes difficult.

For example, when thinking that you will begin content data rental services, it is necessary to manage a rental period, a number of rental or the like of content data and also and it is necessary to manage user's membership.

Moreover, it is expected that methods of managing the above may be different per companies who provides services.

However, the conventional system uses only one user key. It is expected that suitable user management conforming to diversification of such services becomes difficult.

### SUMMARY OF THE INVENTION

A storage medium processing method according to the invention uses a storage medium and a user terminal. The storage medium stores medium identifier data, medium unique key data enabled to be generated based on the medium identifier data, encrypted user key data in which user key data is encrypted so that it may be decrypted using the medium unique key data, and encrypted content key data in which content key data is encrypted so that it may be decrypted using the user key data. The user terminal to which the storage medium is able to be connected retains encrypted content data in which content data is encrypted so that it may be decrypted using the content key data. The user terminal connected to the storage medium is enabled to access to a license center to obtain various kinds of data. The method comprises a step in which the user terminal requests to the license center an issuance of user key data submitting the medium identifier data; a step in which the license center generates responsive to the request of the user terminal, user key data the user key data being different depending on types of services which the user terminal wishes to receive and the medium identifier data, and delivers the user key data to the user terminal; a step of recording the user key data in a database at the license center; and a step of storing the delivered user key data in the storage medium after encrypting it with the medium unique key at the user terminal.

A storage medium processing device according to the invention may be connected to a storage medium which stores medium identifier data, medium unique key data enabled to be generated based on the medium identifier data, encrypted user key data in which user key data is encrypted so that it may be decrypted using the medium unique key data, and encrypted content key data in which content key data is encrypted so that it may be decrypted using the user key data. The device performs data processing of the storage medium via a user terminal retaining encrypted content data in which content data is encrypted so that it may be decrypted using the content key data. The device comprises a key delivery server generating user key data which is different per types of services which the user terminal wishes to receive, and a user key database storing the user key data generated in the key delivery server.

An storage medium processing program according to the invention uses a storage medium and a user terminal. The storage medium stores medium identifier data, medium unique key data enabled to be generated based on the medium identifier data, encrypted user key data in which user key data is encrypted so that it may be decrypted using the medium unique key data, and encrypted content key data in which content key data is encrypted so that it may be decrypted using the user key data. The user terminal to which the storage medium is able to be connected retains encrypted content data in which content data is encrypted so that it may be decrypted using the content key data The user terminal connected to the storage medium is enabled to access to a license center to obtain various kinds of data. The program is configured to perform: a step in which the user terminal requests to the license center an issuance of user key data submitting the medium identifier data; a step in which the license center generates, responsive to the request of the user terminal, user key data, the user key data being different depending on types of services which the user terminal wishes to receive and the medium identifier data, and delivers the user key data to the user terminal; a step of recording the user key data in a database at the license center; and a step of storing the user key data delivered in the storage medium after encrypting it with the medium unique key at the user terminal.

A user terminal according to the invention stores medium identifier data, medium unique key data enabled to be generated based on the medium identifier data, encrypted user key data in which user key data is encrypted so that it may be decrypted using the medium unique key data, and encrypted content key data in which content key data is encrypted so that it may be decrypted using the user key data, and configured to be connected to a user terminal configured to hold encrypted content data in which a content data is encrypted so that it may be decrypted using the content key data. The user key data may be encrypted to a plural kinds of data by the medium unique key data per type of services. At least one of said user key data is user for encrypting the other user key data.

### THE ADVANTAGE OF THE INVENTION

According to this invention, responsive to the request of the user terminal, the user key data which is different depending on types of services which the user terminal wishes to receive and the medium identifier data is generated and delivered to the user terminal. The generated user key data is recorded in a database. In the user terminal, the delivered user key data is stored in the storage medium after being encrypted by the medium unique key. In a word, according to the present invention, different user key data is generated per type of services. Therefore, it is possible to sensitively manage users, which differ per type of services, using user key data. The expression of “type of services” is used to mean that they are different in a certain viewpoint such as a provider of services (an enterprises), an object (what content data includes), procedures, or other characteristics.

### EMBODIMENTS

Hereafter, embodiments of the present invention will now be described with reference to the drawings.

FIG. 1 is a diagram showing the configuration of the storage-medium processing system according to the embodiment of the present invention.

The same numerals are given to the same parts as FIG. 9, and detailed explanation is omitted for these parts. Different parts are hereafter mainly described.

Specifically, in the system of this embodiment, a user terminal 20, holding a SD card SDq freely attachable and detachable therein, is enabled to communicate through a network 30 to the license center unit 40. In this SD card SDq, plural kinds of user keys (hereinbelow referred to as a service user key) Kus, which are different per type of services, may be stored In this example, content keys Kc1, Kc2, and Kc3 shall be encrypted by three kinds of service user key Kus1, Kus2, and Kus3, respectively. Each service user key Kus holds metadata, respectively. The metadata can include data of the expiry term of the keys or the like, for example.

The plural kinds of service user keys Kus are encrypted with the medium unique key Kmu, and are stored in the protection area 3.

In addition to this service user key Kus, another user key Kumst is stored in the protection area 3, encrypted by the medium unique key Kmu. This user key Kumst (hereinafter referred to as a “master user key”) is a key used in order to encrypt the service user key Kus, when acquiring the service user key Kus from the license center unit 40.

This master user key Kumst may be given only a function of encrypting the service user key Kus. Alternatively, in addition to this function, it may have general functions as a user key encrypting a content key as well as the service user key Ku.

The user terminal 20 is equipped with a memory 21, a download unit 22, a SD card processing unit 23, and a control unit 25. For a user terminal 20, any arbitrary device may be used, if it is an electronic instrument holding a SD card SDq attachable and detachable therein, such as a personal computer, a portable cellular phone, or a portable information terminal (personal digital assistant).

The memory 21 is a memory area which may be read and written from another unit 22-25. For example, the encrypted content data Enc (Kc, C) is stored therein.

The download unit 22 is controlled by the control unit 25, and it has a function of downloading the encrypted content key data Enc (Ku, Kc) and user keys from the license center unit 40 For example, browser software or the like may be used therefor. The SD card processing unit 23 is controlled by the control unit 25, and has a function of authentication toward a SD card SDq, a cipher communication, and reading/writing data stored in each of the areas 1, 3, and 4. The control unit 25 has usual computer functions and a function of controlling each of the units 21-24 according to operation of a user.

The license center unit 40 comprises a key delivery server 41, a medium identifier database 42, a master user key database 43, a service user key database 44, a content key database 46, and an authenticated content ID database 47.

The key delivery server 41 receives from the user terminal 20 through a network 30 a request of transmitting a content key.

In this case, after experiencing a certain authentication process, the key delivery server 41 has a function of returning to the user terminal 20 through a network 30 new content key data concerning the request.

Moreover, when a user key delivery request is received from the user terminal 20 through the network 30, the key delivery server 41 has a function of accessing the databases 42 or the like, to generate user key data concerning the request, and to return the user key data or the like to the user terminal 20 via the network 30.

The medium key database 42 holds data of the medium identifier IDm which each SD card has. The master user key database 43 is for storing data of the master user key Kumst which each SD card has. The service user key database 44 holds data of the service user key Kus which an SD card has.

The content key database 46 holds various content keys. The authenticated content ID database 47 holds data of the content key data issued according to the request of an SD card owner, in relation to the medium identifier IDm of the SD card.

The security module 51 is a unit that performs encryption/decryption processing of the user key Ku and the content key Kc, and is equipped with the management key obtaining unit 52, and the key encryption management unit 53 The management key obtaining unit 52 holds the management key readable from the key delivery server 41.

The key encryption management unit 53 has a function of receiving a setup of a management key by the key delivery server 41, decoding the encrypted user key for management and the encrypted content key for management respectively, which are received from the key delivery server 41 based on the management key to obtain a user key and a content key, encrypting the content key and basic metadata with the user key, and transmitting to the delivery server 41 the encrypted content key (with basic metadata included therein) obtained and (additional) metadata such as a purchase date or the like.

Next, a storage-medium processing method conducted by the storage-medium processing system constituted as mentioned above is explained, using FIGS. 2 to 4.

In this system, as mentioned above, each SD card SDq is equipped with a master user key Kumst and a different service user key Kus per type of services Each SD card SDq acquires a master user key Kumst first, and subsequently acquires the service user key Kus corresponding to a desired services. Thereafter, it acquires a content key Kc using this service user key Kus.

(Obtaining of Master User Key Kumst)

The Procedure in which the SD card SDq accesses the license center unit 40 through the user terminal 20, and acquires a master user key Kumst first is explained with reference to FIG. 2.

In the user terminal 20,the control unit 25 starts the download unit 22 according to the operation of a user, The SD card processing unit 23 reads the medium identifier IDm of the SD card SDq from the system area 1 (S11), and generates the random number R1 (S12).

This random number R1 is generated for authentication under challenge response using a common-key-encryption scheme, and for generation of a session key, in order to perform secure communication between the user terminal 20 and the license center unit 40.

Subsequently, the download unit 22 transmits a acquisition request of a master user key Kumst to the key delivery server 41 (ST13) This acquisition request contains the medium identifier IDm of the SD card SDq and the generated random number R1.

The key delivery server 41 generates the master user key Kumst, after experiencing a predetermined authentication procedure etc. in response to this acquisition request (S14). And the data of this master user key Kumst is related to the medium identifier IDm, and is stored in the master user key database 43 (S15). Then, the key delivery server 41 generates a random number R2 (S16). Like the random number R1, this random number R2 is generated for authentication under challenge response using a common-key-encryption scheme, and for generation of a session key in order to perform secure communication between the user terminal 20 and the license center unit 40.

Then, the session key Ks is generated using the random number R1 received from the SD card processing unit 23, this random number R2, and the secret information K1, K2 as a common encryption key(S17).

The key delivery server 41 encrypts the generated master user key Kumst with this generated session key Ks using the security module 51(ST18), and transmits the master user key data Kumst encrypted using the simple object access protocol message with the random number R2 to the SD card processing unit 23 through the download unit 25 (ST19).

The SD card processing unit 23 generates the session key Ks from the random number R1, R2 and the secret information K1, and K2 (ST20) and decodes encrypted master user key Kumst with the session key Ks. This decoded master user key Kumst is again encrypted by the SD card processing unit 23 using the medium unique key Kmu, and is written in the protection area 3 of the SD card SDq (S22). This ends an obtaining process of a master user key Kumst.

(Obtaining Process of the Service User Key Kus)

Next, the Procedure in which the SD card SDq accesses the license center unit 40 through the user terminal 20, and acquires the service user key Kus is explained with reference to FIG. 3.

When the control unit 25 starts the download unit 22 by the operation of a user in the user terminal 20, the download unit 22 reads the medium identifier IDm from the system area 1 of SD card SDq (S30). Thereafter it transmits to the key delivery server 41 the medium identifier IDm and an acquisition request of a service user key containing a service ID corresponding to the service user key Kus to be acquired (S31).

The key delivery server 41 receives this acquisition request and reads from the master user key database 43 a master user key Kumst for management stored for every medium identifier IDm beforehand (a master user key Kumst acquired beforehand in the SD card SDq transmitting a request) (S32).

And the key delivery server 41 reads and acquires an encrypted service user key Kus for management stored for every service ID beforehand from the service user key database 44 (S33). In some cases the SD card SDq transmitting a request haven't finished acquiring process of a master user key Kumst and the master user key database 43 does not store a master user key Kumst corresponding to the medium identifier IDm which the card SDq has. In this case, it sends a message noticing that, and urges acquiring a master user key Kumst before obtaining the service user key Kus.

The key delivery server 41 stores in the service user key database 44 the service user key Kus in relation to the medium identifier IDm, and encrypts it with the master user key Kumst (S34). And it transmits the encrypted service user key Kus to the user terminal 20 by a simple object access protocol (Simple Object Access Protocol) message (S35). Note that a simple object access protocol message is an example of a message system, and it is needless to say that it may be changed to other systems.

In the user terminal 20 the download unit 22 which received the simple object access protocol message transmits the encrypted service user key Kus to the SD card processing unit 23 The SD card processing unit 23 decodes this encrypted service user key Kus by the master user key Kumst stored in the protection area 3 (S36). And it encrypts again the service user key Kus with the medium unique key Kmu which the SD card SDq has, and stores it in the protection area 3 (S37). Thereby, an obtaining process of the service user key Kus is completed.

As mentioned above, this service user key Kus is prepared per type of services. For example, a service user key Kus1 is for selling content data (for sale), and a service user key Kus2 is for rental of content data In this case, a different service ID is given to each, respectively. Therefore, in order to acquire each service user key Kus1 and Kus2, it is necessary to show each service ID and to perform the above-mentioned procedure.

Moreover a transmission of the key by challenge response using common key encryption system (random numbers R1, R2, and the secret information K1, K2 are used therein) is limited to one time when a transmission of a master user key Kumst is transmitted. Challenge response is not performed in the case of a transmission of the service user key Kus. Thereby, a communication speed can be increase, while keeping a communication security level high.

(A Obtaining Process of a Content Key)

A procedure in which the SD card SDq acquires the content key Kc through the user terminal 20 is explained with reference to FIG. 4. In the user terminal 20, by operation of a user, the control unit 25 starts the download unit 22 and it checks that the download unit 22 has finished purchasing or finished accounting about a content key beforehand (S41). If not, the user terminal 20 performs purchase and accounting processes of a content key with the license center unit 40 and changes the content key into the status that it is already purchased and charged.

Then, the download unit 22 transmits an acquisition request of data of the encrypted content key Kc to the key delivery server 41 (S42). In this example, data of the medium identifier IDm, a service ID which shows a service to be wished, and a content ID of the content key Kc to be obtained, shall be contained in an the acquisition request.

The key delivery server 41 receives this acquisition request, and reads the encrypted master user key for management and the encrypted service user key for management which were beforehand stored for every medium identifier IDm, from the master user key database 43 and the service user key database 44, respectively(S43). And the encrypted content key Kc for management and basic metadata (the content ID, the title, the maker, and others) concerning the specified content ID are read from the content key database 46 (S44).

Thereafter, the key for management is read from the management key obtaining unit 52 (S45) The key delivery server 41 sets this key for management at the key encryption management unit 53 (S46). And it transmits the request of encrypting the content key Kc to the key encryption management unit 53 (S47). Note that this encryption request contains the encrypted user key for management, the encrypted content key for management, and the basic metadata.

Based on the key for management, the key encryption management unit 53 decodes the encrypted content key for management, and gets the content key Kc (S48). Thereafter, the key encryption management unit 53 encrypts the content key Kc and basic metadata with the service user key Kus, and transmits the encrypted content key Kc (basic metadata is included therein) and metadata (it is additional) such as an acquisition date to the key delivery server 41 (S48).

When the additional metadata is read (S49) the key delivery server 41 generates a simple object access protocol (Simple Object Access Protocol) message containing the encrypted content key Kc and metadata for example (S50) The encrypted content key Kc and the metadata are transmitted to the user terminal 20 by a simple object access protocol message (551). Note that a simple object access protocol message is an example of a message system, and it is needless to say that it may be changed into other systems.

In the user terminal 20, the download unit 22 which received the simple object access protocol message transmits a request of saving the encrypted content key Kc to the SD card processing unit 23 (S52) Note that the request of saving the encrypted content key Kc contains only the encrypted content key Kc among the encryption content key Kc and the metadata. The SD card processing unit 23 writes this encrypted content key Kc in the user data area 4 of the SD card SDq

Moreover, the download unit 22 saves the metadata which was not sent out to the SD card processing unit 23 (S53). This ends an obtaining process of the content key Kc. This content key Kc can be decrypted only with the service user key Kus submitted at the time of acquisition request.

As mentioned above, in this embodiment, one SD card SDq is enabled to hold several service user keys Kus different per type of services of the like The examples of the embodiments are explained with reference to FIGS. 5-8 below.

In the example of FIG. 5, one SD cards SDq is configured to hold plural service user keys Kus1-Kus4 which are different per category of content data to be provided. All service user key Kus are encrypted by the master user key Kumst at the time of acquisition and is transmitted to the user terminal 20 from the license center unit 40

In the example of FIG. 6, one SD cards SDq is configured to hold plural service user keys Kus1-Kus4 which are different per content provider (company A, B) and style of delivery (for sale, or rental).

By changing service user keys per company, each company can manage user's memberships or the like uniquely on a service user key base For example, when membership requirements differ between Company A and B, each company can include the difference in the metadata of each service user key uniquely.

Moreover, by preparing service user keys separately for one for sale and one for rental a rental term of content data, a expiry term or the like can be uniquely set up in every service user keys Kus1-Kus4.

For example the service user key for sale and the service user key for rental each may have a different expiry term. Thereby review periods of rental membership can be set up proper on a service user key.

FIG. 7 shows an example that issues service user keys which are different for combination of different categories of content data, different delivery companies and styles of delivery.

FIG. 8 shows the system in which a plurality of SD cards SDq (1-4) may be registered as “family cards”, and any one of the owners of the SD cards (1-4) obtained a content key Kc, the other family card owner can share the content key Kc. Here, a family card system means a system plural persons who have specific relation such as a family own a card respectively, can receive privileges such as discount.

For example, as shown in FIG. 8, let it suppose that the owner of The SD card SDq1 has obtained a content key Kc1 based on service user key Kus1-1. In this case, the owner of other family cards SDq 2-4 can share that content key Kc1 (FIG. 8). Each family card SDq 1-4 has different service user key Kus-1-4 respectively about the same services However, each service user key Kus-1-4 are equipped with the same family card ID in order to show that it is a family card. By having this family card ID, the owners of the family card SDq 2-4 can receive the content key Kc1 without accounting when they transmits to the license center unit 40 acquisition request of content key Kc1 submitting a content ID for that content key Kc1 and the family card ID.

Among plural SD cards thus registered as a family card, a range of the the SD cards which shares a content key may be determined according to the types of the user terminals 20 to which the SD card is inserted For example, as shown in FIG. 8, let us suppose the case where the SD card SDq1 is inserted into a desktop computer, the SD card SDq2 into a notebook computer, the SD card SDq3 into a DVD recorder, and the SD card into a portable audio player, respectively. In this case, a musical content key (Kc1) can be shared by all the SD cards. On the other hand, the content key (Kc2) of video can be shared among SD cards other than SD card SDq4 inserted in the portable audio player which is an audio special-purpose machine. Moreover, the content key (Kc3) of a game can be shared by the SD card SDq1 and SDq2 only, which were inserted in the computer equipment. Such a process can be performed by checking family card IDs, master user keys Kumst, etc., for example, by the key delivery server 41. In the user terminal 20, a modification where the SD card processing unit 23 or the like may be set up so that only the content keys according to the properties of the user terminal can be downloaded is also possible.

Moreover, the range of the SD cards in which a content key is shared may be determined by the genre of content data. For example, when the movie belongs to specific genres (a violence, parental guidance suggested, etc.), the content key is avoided from being shared in a specific SD card (for example, a SD card owned by a child). Such a process can also be performed by checking family card IDs, master user keys Kumst, etc. by the key delivery server 41. Alternatively, the SD card processing unit 23 may be set so that such a content key cannot be downloaded.

Note that the process described in each of above-mentioned embodiments can be implemented by a program which can make a computer perform the process. The program can be stored in a storage medium such as magnetic disks (a floppy (registered trademark) disk, a hard disk, etc.), an optical disk (CD-ROM, DVD etc.), a magneto-optical disk (MO), and a semiconductor memory.

Moreover, as this storage medium, scheme for storing may be of any type, as long as it is a storage medium enabled to store a program readable by a computer.

Moreover, operating system (OS) working on a computer based on an indication of the program installed in the computer from the storage medium, a database management software, and a middleware such as network software, can implement part of the processes for realizing the embodiments.

Furthermore, the storage medium in the present invention is not limited to the medium that is independent of a computer. It may be a storage medium that downloads the program transmitted by a local area network (LAN) or the Internet, etc., and stores or temporarily stores it.

Moreover, a storage medium is not limited to a single one. When the processes in the embodiments are performed by a plurality of media, the media are included in the storage medium according to the present invention. In addition, the medium configuration cay be any type.

Note that a computer in the present invention is configured to perform each process in the embodiments based on a program stored in a storage medium. It may have any configurations For example, it may be a single device such as a personal computer, or a system having a plurality of network-connected computers.

Moreover, a computer in the present invention is not limited to a personal computer, but includes a operation processing device included in a information processing device, and a microcomputer. It includes devices or apparatuses that can realize the function of the present invention by a program.

Moreover, in the above-described embodiments, each SD card SDq acquires a master user key Kumst by a common key encryption scheme using the challenge response. Thereafter, the service user key Kus is acquired by encryption using this master user key Kumst.

However, the present invention is not limited to those embodiments. The service user key Kus may be directly acquired from the medium identifier IDm etc. In this case, The procedure of publishing a master user key can be skipped, though it is necessary to use common encryption scheme using a challenge response for a transmitting the service user key Kus one by one.

This system is effective, when there is little category of service user key, or when the expiry term of a service user key is long.

Note that the present invention is not limited to the above-described embodiments themselves. In a practice phase, their components can be modified and embodied, as long as it does not depart from the spirit thereof. Moreover, merging two or more proper components indicated by the above-mentioned embodiments can form various inventions. For example, some components may be deleted from all the components shown in the embodiments. Furthermore, the components employed in different embodiments may be combined suitably.

### BRIEF DESCRIPTION OF THE DRAWINGS

FIG. 1 is a diagram illustrating a configuration of a storage medium processing system according to an embodiment of the present invention.

FIG. 2 explains procedures for obtaining a master user key Kumst.

FIG. 3 explains procedures for obtaining a service user key Kus.

FIG. 4 explains procedures for obtaining a content key by a SD card SDq via a user terminal 20.

FIG. 5 explains an example of embodiments in which one SD card SDq is enabled to hold a plurality of the service user keys Kus.

FIG. 6 explains an example of embodiments in which one SD card SDq is enabled to hold a plurality of the service user keys Kus.

FIG. 7 explains an example of embodiments in which one SD card SDq is enabled to hold a plurality of the service user keys Kus.

FIG. 8 explains an example of embodiments in which one SD card SDq is enabled to hold a plurality of the service user keys Kus.

FIG. 9 is a diagram showing the configuration of the SD card and a user terminal conforming to the encryption double key scheme conventionally adopted in MQbic.

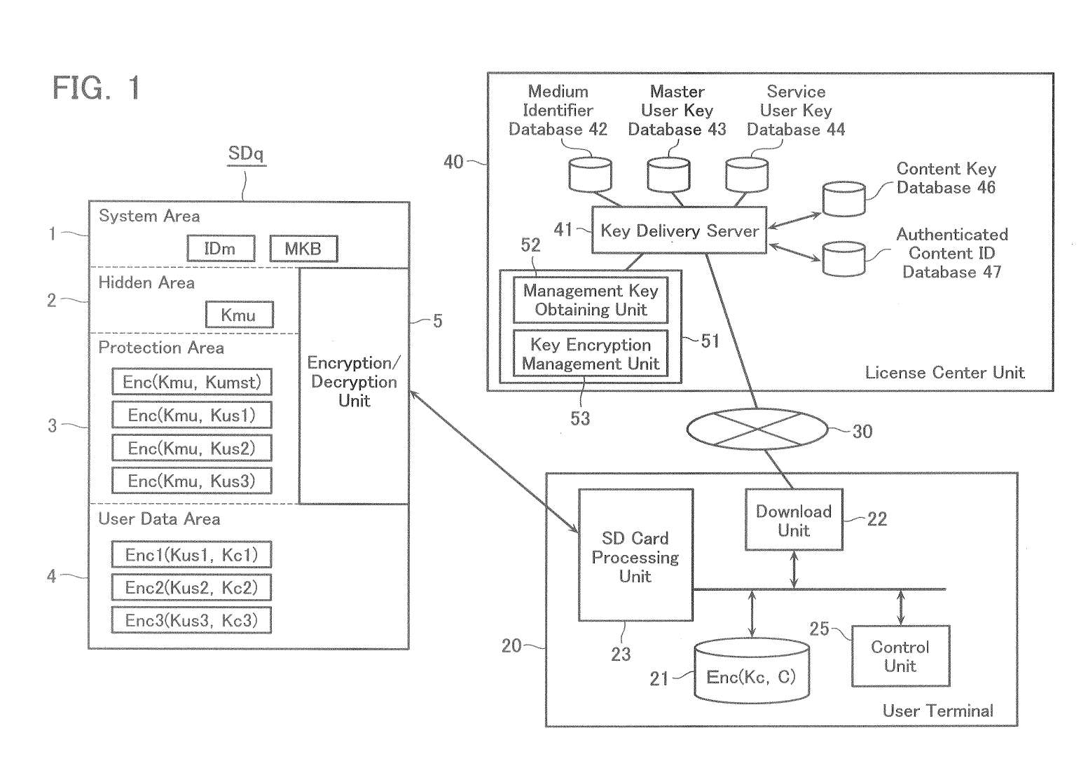

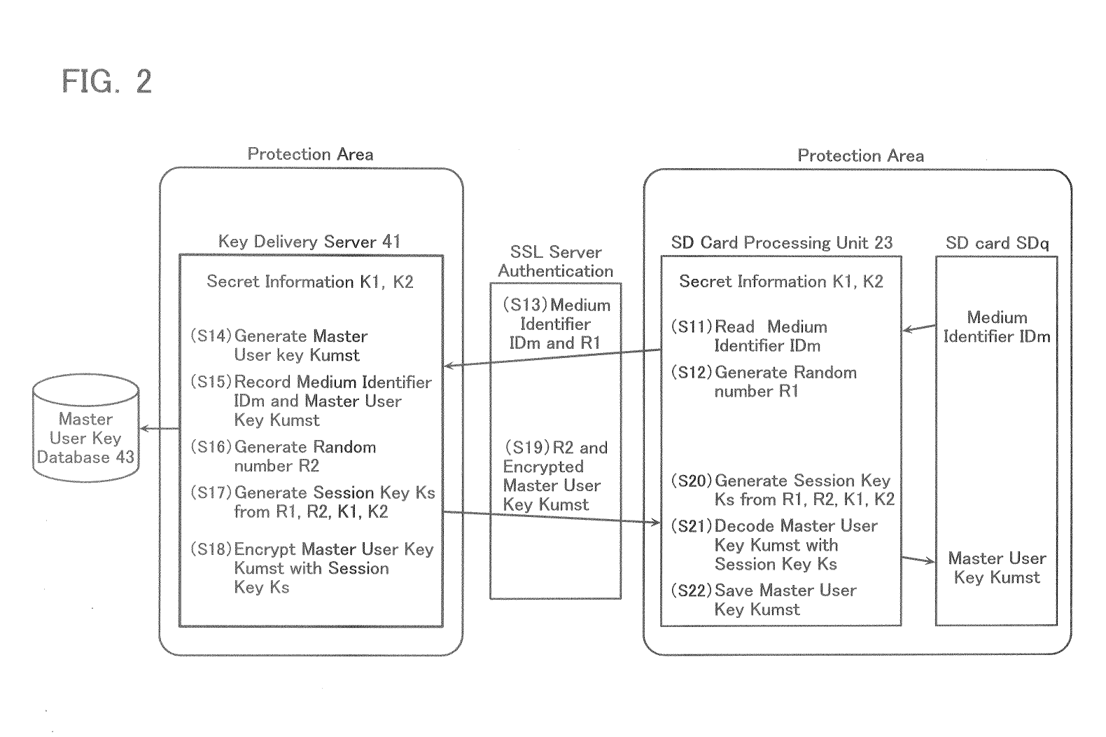

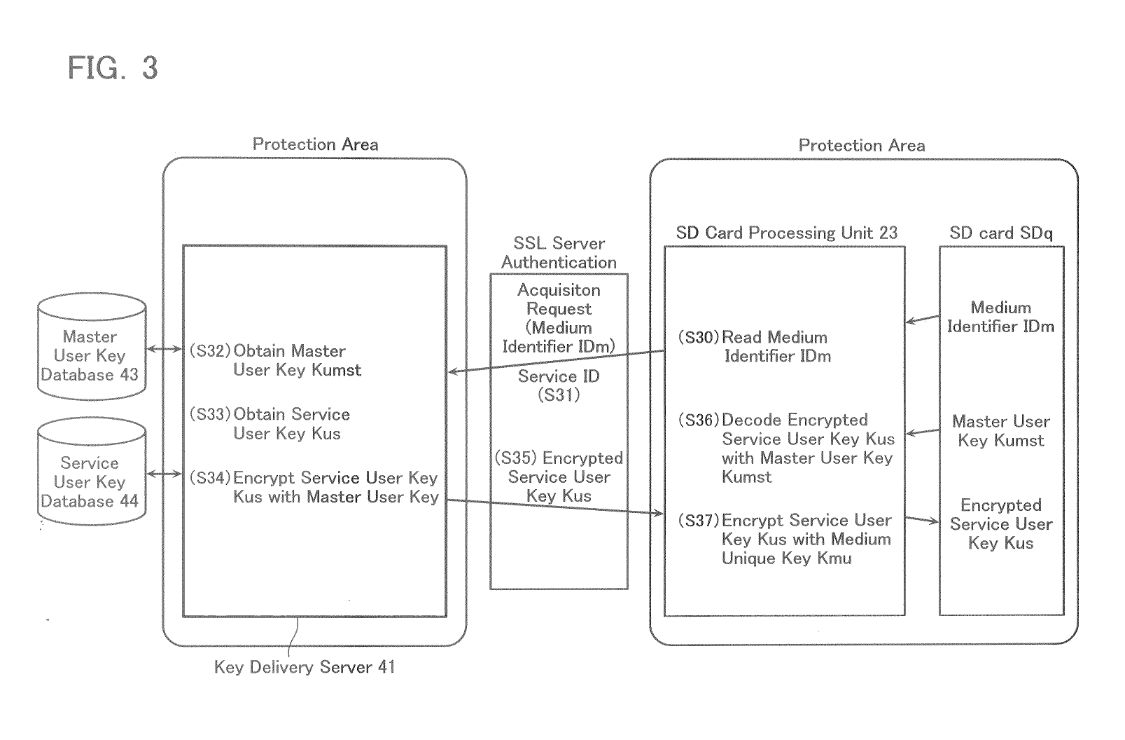

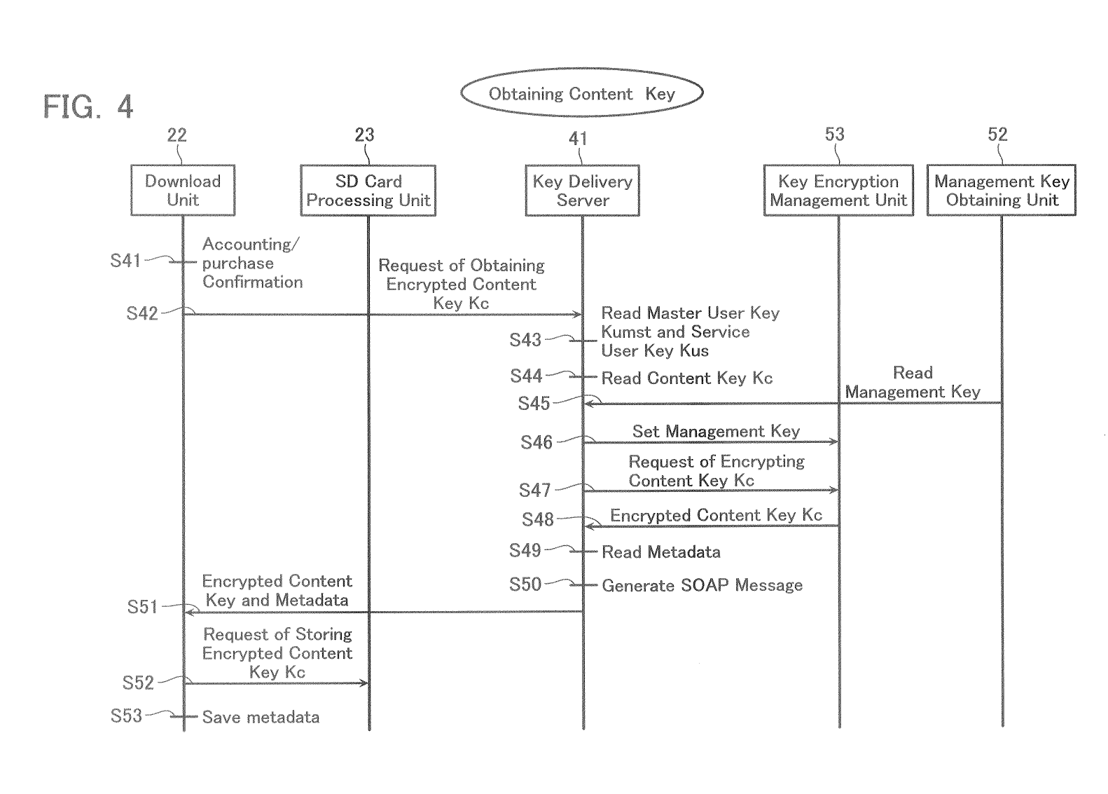

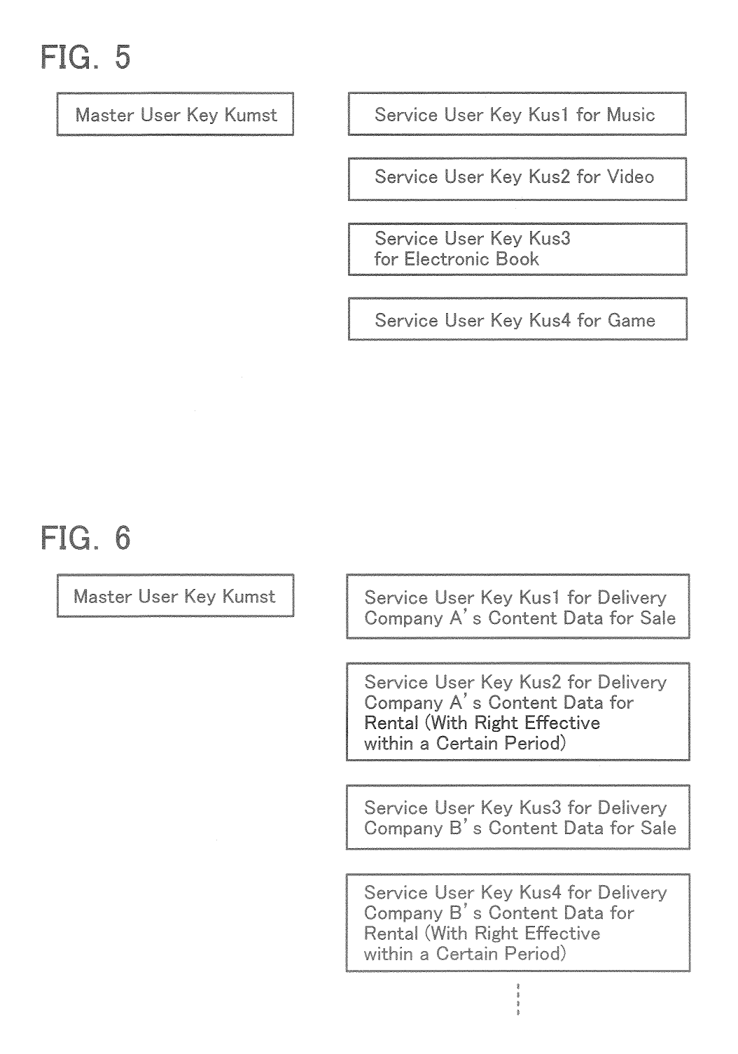

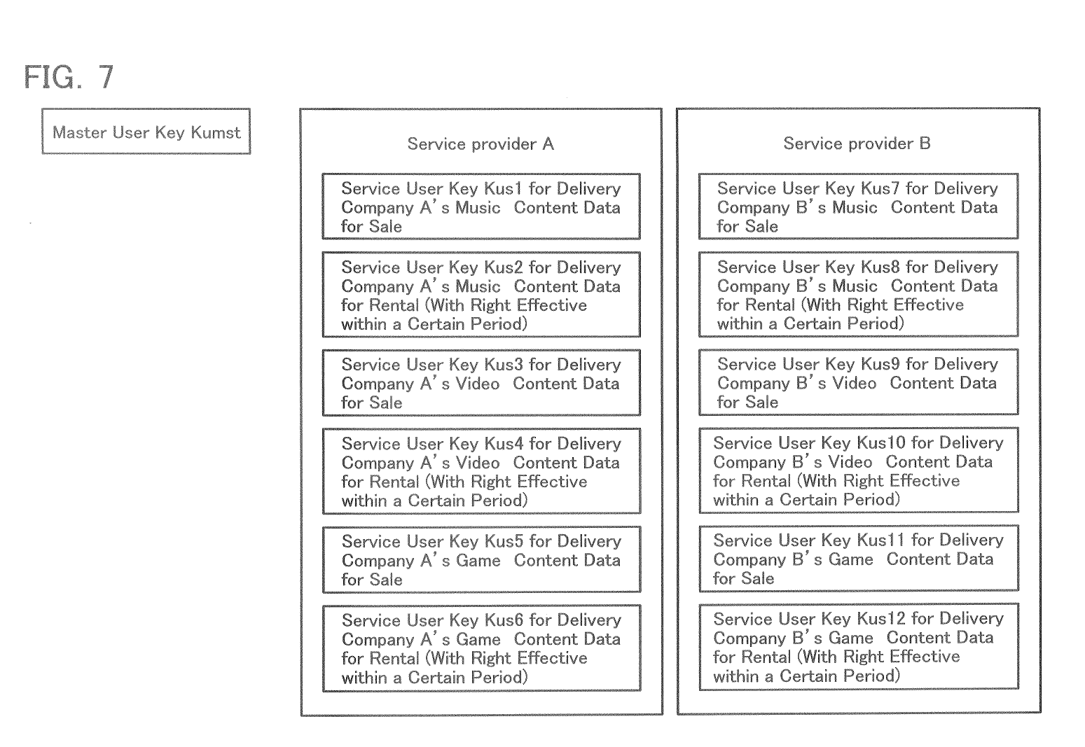

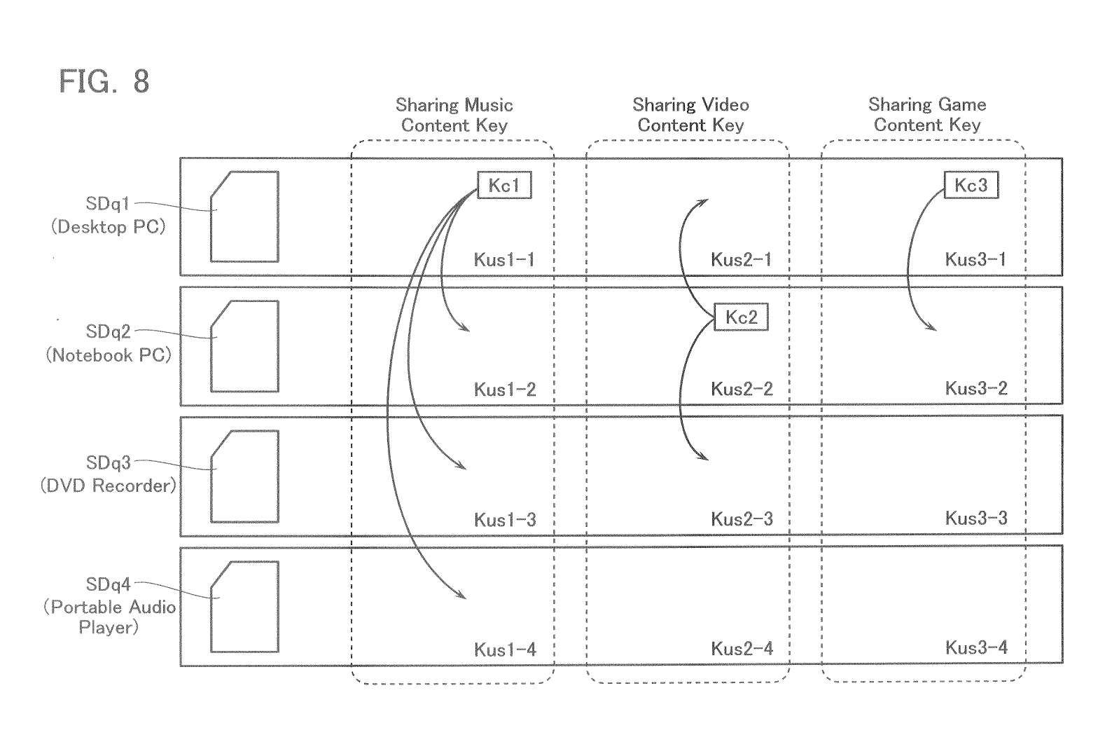

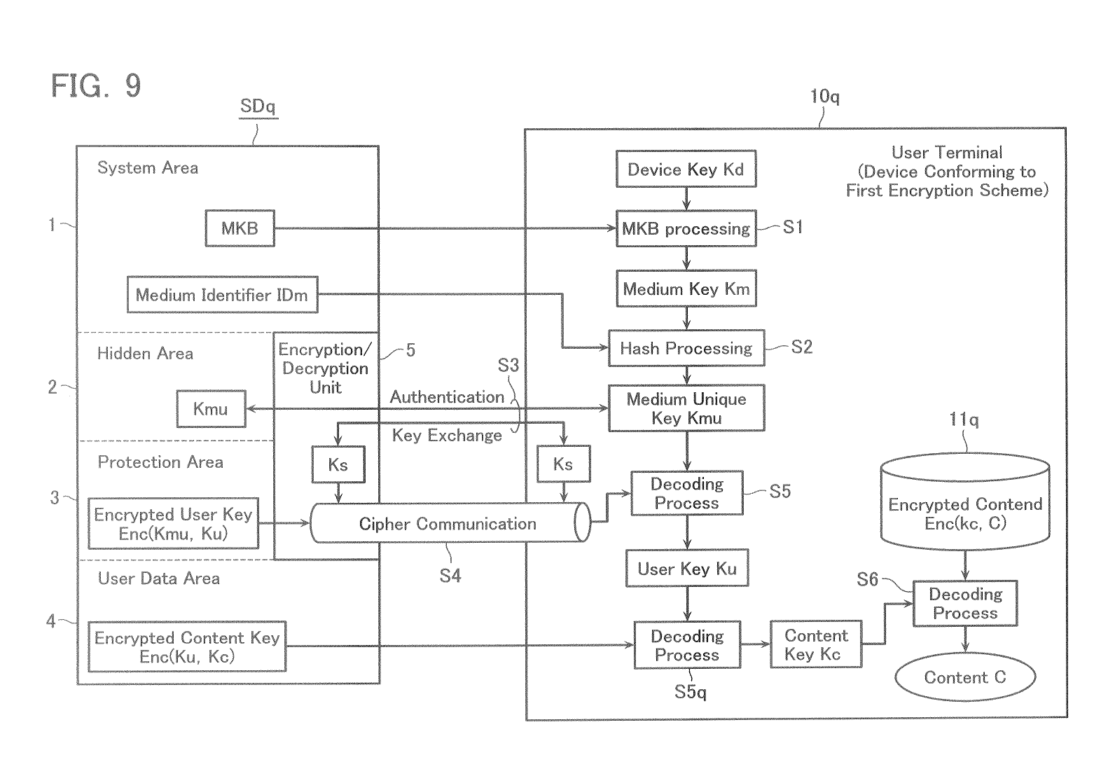

### AN EXPLANATION OF SYMBOLS

SDq . . . an SD card
1 . . . a system area
2 . . . a hidden area
3 . . . a protection area
4 . . . a user data area
5 . . . a encryption/decryption unit
20 . . . a user terminal
21 . . . a memory
22 . . . a download unit
23 . . . a SD card processing unit
25 . . . a control unit
40 . . . a license center unit,
41 . . . a key delivery server
42 . . . a medium key database
43 . . . a master user key database
44 . . . a service user key database
45 . . . a update history database
46 . . . a content key database
47 . . . an authenticated content ID database
51 . . . a security module
52 . . . a management key obtaining unit
53 . . . a key encryption management unit

1. A storage medium processing method a using a storage medium and a user terminal,
wherein the storage medium stores a medium identifier data, a medium unique key data enabled to be generated based on the medium identifier data, an encrypted user key data in which a user key data is encrypted so that it may be decrypted using the medium unique key data, and encrypted content key data in which a content key data is encrypted so that it may be decrypted using the user key data,
the user terminal retains an encrypted content data in which content data is encrypted so that it may be decrypted using the content key data, and
the user terminal connected to the storage medium is enabled to access to a license center to obtain various kinds of data,
the method comprising:
a step in which the user terminal requests to the license center an issuance of user key data submitting the medium identifier data;
a step in which the license center generates, responsive to the request of the user terminal, user key data, the user key data being different depending on types of services which the user terminal wishes to receive and the medium identifier data, and delivers the user key data to the user terminal;
a step of recording the user key data in a database at the license center; and
a step of storing the delivered user key data in the storage medium after encrypting it with the medium unique key at the user terminal.

2. A storage medium processing method according to claim 1, wherein the step of delivering the user key data to the user terminal encrypts the generated user key data using a specific user key data transmitted beforehand, and transmits it.

3. A storage medium processing method according to claim 2, wherein the specific user key data is used to encrypt other user key data, and also used to encrypt content key data concerning a specific service.

4. A storage medium processing method according to claim 2, wherein the specific user key data is used to encrypt other user key data only.

5. A storage medium processing device which may be connected to a storage medium which stores medium identifier data, medium unique key data enabled to be generated based on the medium identifier data, encrypted user key data in which user key data is encrypted so that it may be decrypted using the medium unique key data, and encrypted content key data in which content key data is encrypted so that it may be decrypted using the user key data, and performs data processing of the storage medium via a user terminal retaining encrypted content data in which content data is encrypted so that it may be decrypted using the content key data,
the device comprising:
a key delivery server generating user key data which is different per types of services which the user terminal wishes to receive; and
a user key database storing the user key data generated in the key delivery server.

6. A storage medium processing device according to claim 5, wherein the key delivery server shares secret key data used for common key encryption scheme with the user terminal,
wherein specific user key data out of the user key data is encrypted by the secret key data, and the other user key data is encrypted by the specific user key data and is transmitted to the user terminal.

7. A storage medium processing device according to claim 6, wherein the specific user key data is used to encrypt other user key data, and also used to encrypt content key data concerning a specific service.

8. A storage medium processing device according to claim 6, wherein the specific user key data is used to encrypt the other user key data only.

9. A storage medium processing program a using a storage medium and a user terminal,
wherein the storage medium stores medium identifier data, a medium unique key data enabled to be generated based on the medium identifier data, an encrypted user key data in which a user key data is encrypted so that it may be decrypted using the medium unique key data, and encrypted content key data in which a content key data is encrypted so that it may be decrypted using the user key data,
the user terminal retains an encrypted content data in which a content data is encrypted so that it may be decrypted using the content key data, and
the user terminal connected to the storage medium is enabled to access to a license center to obtain various kinds of data,
the program is configured to perform:
a step in which the user terminal requests to the license center an issuance of user key data submitting the medium identifier data;
a step in which the license center generates, responsive to the request of the user terminal, user key data, the user key data being different depending on types of services which the user terminal wishes to receive and the medium identifier data, and delivers the user key data to the user terminal;
a step of recording the user key data in a database at the license center; and
a step of storing the user key data delivered in the storage medium at the user terminal after encrypting it with the medium unique key.

10. A user terminal which may be connected to a storage medium which stores medium identifier data, medium unique key data enabled to be generated based on the medium identifier data, encrypted user key data in which user key data is encrypted so that it may be decrypted using the medium unique key data, and encrypted content key data in which content key data is encrypted so that it may be decrypted using the user key data, the user terminal being configured to hold encrypted content data in which a content data is encrypted so that it may be decrypted using the content key data,
the user terminal comprising:
a transmitting/receiving unit configured to transmit a request of issuance of user key data while submitting data concerning types of services wished and the medium identifier data to a license center, and receive user key data which is different per type of the services and the medium identifier data; and
a storage medium processing unit that encrypts the user key data received with the medium unique key and stores it in the storage medium.

11. A user terminal according to claim 10, wherein secret key data used for common key encryption scheme is shared with the license center, and
the transmitting/receiving unit is configured to receive specific user key data out of the user key data in a form it is encrypted by the secret key data, and decrypt it with the secret key data, while receiving the other user key data in a form it is encrypted by the specific user key data and decoding it with the specific user key data.

12. A storage medium storing medium identifier data, medium unique key data enabled to be generated based on the medium identifier data, encrypted user key data in which user key data is encrypted so that it may be decrypted using the medium unique key data, and encrypted content key data in which content key data is encrypted so that it may be decrypted using the user key data, and configured to be connected to a user terminal configured to hold encrypted content data in which a content data is encrypted so that it may be decrypted using the content key data,
wherein said user key data may be encrypted to a plural kinds of data by the medium unique key data per type of services, and
at least one of said user key data is user for encrypting the other user key data.

13. A storage medium according to claim 12, wherein each of the plurality of user key data holds metadata, respectively.
